(19) United States
(12) Patent Application Publication
(10) Pub. No.: US 2020/0060480 A1
(43) Pub. Date: Feb. 27, 2020

(54) FOOD PROCESSOR

(71) Applicant: Ningbo BorDon Electric Appliance Co., Ltd, Yuyao city (CN)

(72) Inventor: Fulong ZHU, Yuyao City (CN)

(21) Appl. No.: 16/132,823

(22) Filed: Sep. 17, 2018

(30) Foreign Application Priority Data
Aug. 22, 2018 (CN) 201810960235.3

(51) Int. Cl. A47J 43/07; A47J 43/08; A47J 43/046

(52) U.S. Cl. CPC A47J 43/0722; A47J 43/046; A47J 43/085

(57) ABSTRACT

A food processor disclosed in the present invention includes a base and a cup body. The base includes a first accommodating cavity, a second accommodating cavity, a drive device and a grinding blade. The grinding blade is connected to the drive device. The cup body is detachably connected to the second accommodating cavity. The cup body includes a first surface, and a second surface that forms a third accommodating cavity with the first surface. The second accommodating cavity and the third accommodating cavity form a food grinding and processing cavity which is provided with a pressure release device including a pressure release hole and an air release valve. The air release valve is movably mounted in the pressure release hole so as to move along an axial direction of the pressure release hole to open or block the pressure release hole. The food processor is safe and reliable in use.

### TECHNICAL FIELD

The present invention relates to the field of small home appliances, and in particular, to a food processor with an air release valve.

### BACKGROUND ART

When a food processor processes food into liquid, two thirds or three quarters of the volume of a cup body will be filled with liquid food, and a third or a quarter of the space is left. A lot of heat is generated when a grinding blade rotates at a high speed. The heat is transferred to the liquid. When the heat reaches a certain value, it will vaporize the liquid, forming water vapor. In this case, as only a third or a quarter of the space may be left in the cup body, the water vapor expands rapidly to fill the remaining space in the cup body, causing the cup body to thermally expand continuously. With the increase of grinding time, the temperature and pressure in the cup body are also gradually increased. When the food processor has been used for a long time (more than 1 min), the cup body of the food processor will explode if the pressure and steam inside the cup body are not released in time.

It is not easy to open the cup body due to the excessive thermal expansion pressure and high temperature inside the cup body. Therefore, it is necessary to arrange a pressure release structure for a food processor.

### SUMMARY OF THE INVENTION

An objective of the present invention is to provide a food processor that can automatically release the pressure according to the pressure inside a cup body of the food processor, and then adjust the pressure inside the cup body of the food processor to keep the internal and external pressures stable, making it safer and more convenient for users to use.

In order to achieve the foregoing objective, the present invention proposes the following technical solution:

A food processor, including a base that includes a first accommodating cavity, a second accommodating cavity, a drive device disposed in the first accommodating cavity, and a grinding blade disposed in the second accommodating cavity; the grinding blade being connected to the drive device in a driving manner; and a cup body that covers the grinding blade and is detachably connected to the second accommodating cavity, wherein the cup body includes a first surface, and a second surface that surrounds the first surface and forms a third accommodating cavity with the first surface; the second accommodating cavity and the third accommodating cavity form a food grinding and processing cavity; and the food grinding and processing cavity is provided with a pressure release device that includes a pressure release hole and an air release valve, the air release valve being movably mounted in the pressure release hole so as to move along an axial direction of the pressure release hole to open or block the pressure release hole.

Further, the pressure release hole is disposed on the first surface, and at least one pressure release table is disposed on the periphery, which is located in the third accommodating cavity, of the pressure release hole. The air release valve includes a first retainer ring, a second retainer ring and a valve stem that connects the first retainer ring to the second retainer ring. The valve stem is disposed through the pressure release hole such that the first retainer ring is located outside the third accommodating cavity, and the second retainer ring is located in the third accommodating cavity. A projection area of the first retainer ring on the pressure release hole is greater than an area of the pressure release hole, so as to block the pressure release hole; and a projection area of the second retainer ring on the pressure release hole is greater than the area of the pressure release hole.

Further, the diameter of the valve stem is gradually reduced from the first retainer ring to the second retainer ring.

Further, a space is provided between the pressure release tables.

Further, the pressure release tables are equally spaced around the pressure release hole.

Further, a pit is disposed on the first surface, the pressure release hole is opened on the pit, and the depth of the pit is greater than the thickness of the first retainer ring.

Further, the first retainer ring is provided with a handheld end.

Further, the air release valve is a soft rubber valve.

The present invention has the following technical effects:

The food processor in the present invention can adjust the pressure inside the food processor according to usage requirements. In the adjustment process, air flow in a stirring cup can flow out of a pressure release hole, and a balance between the internal and external pressures can be achieved through the exchange of internal and external pressures, thus achieving the purpose of pressure release. The whole process of pressure release is automatic and autonomous, without manual operations, and sealing can be restored automatically. The food processor is easy to operate, and users can pay more attention to the grinding degree of food in the food processor at the same time. The pressure release device of the food processor in the present invention has a simple structure, and is easy to operate to block or open the pressure release hole conveniently.

### BRIEF DESCRIPTION OF THE DRAWINGS

The accompanying drawings of the specification that constitute a part of the present application are used to provide further understanding of the present invention. Schematic embodiments of the present invention and descriptions of the embodiments are used to explain the present invention, and do not improperly limit the present invention.

In the drawings:

FIG. 1 is an overall schematic structural diagram of the present invention;

FIG. 2 is a schematic diagram of mounting of a pressure release device onto a cup body according to the present invention;

FIG. 3 is a sectional view of FIG. 2;

FIG. 4 is a schematic diagram of the pressure release process of FIG. 2 (the directions of arrows in the figure are the direction of air flow and the moving direction of a pressure release valve);

FIG. 5 is a first schematic diagram of the cup body in FIG. 2; and

FIG. 6 is a second schematic diagram of the cup body in FIG. 2.

The drawings include the following reference numerals:

base 100, first accommodating cavity 110, second accommodating cavity 120, partition plate 1201, drive device 130, grinding blade 140; cup body 200, first surface 210, third accommodating cavity 220, second surface 230, pit 240; pressure release device 300, pressure release hole 310, pressure release table 311, air release valve 320, first retainer ring 321, second retainer ring 322.

### DETAILED DESCRIPTION

The present invention is described in detail in the following with reference to the accompanying drawings and specific embodiments. Schematic embodiments and descriptions therein are only used to explain the present invention, but do not improperly limit the present invention.

It should be noted that, without a conflict, the embodiments in the present application and features in the embodiments can be combined with each other. The present invention will be described in detail in the following with reference to the accompanying drawings and in combination with embodiments.

It should be noted that the terms used here are merely intended to describe specific implementation manners, but not intended to limit exemplary implementation manners according to the present application. As used here, singular forms are also intended to include plural forms, unless clearly specified in the context. In addition, it should be further understood that when the terms “comprise” and/or “include” are used in the specification, they indicate the existence of features, steps, operations, devices, components and/or their combinations.

It should be noted that the terms “first”, “second”, and so on in the specification, claims and the drawings of the present application are used to distinguish similar objects, but not necessarily to describe a particular order or sequence. It should be understood that such data used can be interchanged under appropriate circumstances, so that the implementation manners of the present application described here could be implemented in an order other than the orders illustrated or described here. In addition, the terms “comprise/include” and “have” as well as any of their variations are intended to cover non-exclusive inclusion, for example, a process, method, system, product or device including a series of steps or units needs not to be limited to the steps or units clearly listed, but may include other steps or units not clearly listed or inherent to the process, method, system, product or device.

For ease of description, spatial relative terms such as “above . . . ,” “over . . . ,” “on an upper surface . . . ,” “upper” and the like can be used here to describe a spatial position relation between a device or feature and another device or feature as shown in the figure. It should be understood that the spatial relative terms are intended to include different orientations of the device in use or operation other than those described in the figure. For example, if the device in the figure is inverted, the device described as “above another device or construction” or “over another device or construction” will then be positioned as “below another device or construction” or “under another device or construction.” Thus, the exemplary term “above . . . ” can include two orientations of “above . . . ” and “below . . . ”. The device can also be positioned in other different manners (rotated by 90 degrees or in another orientation), and the spatial relative descriptions used here can be correspondingly explained.

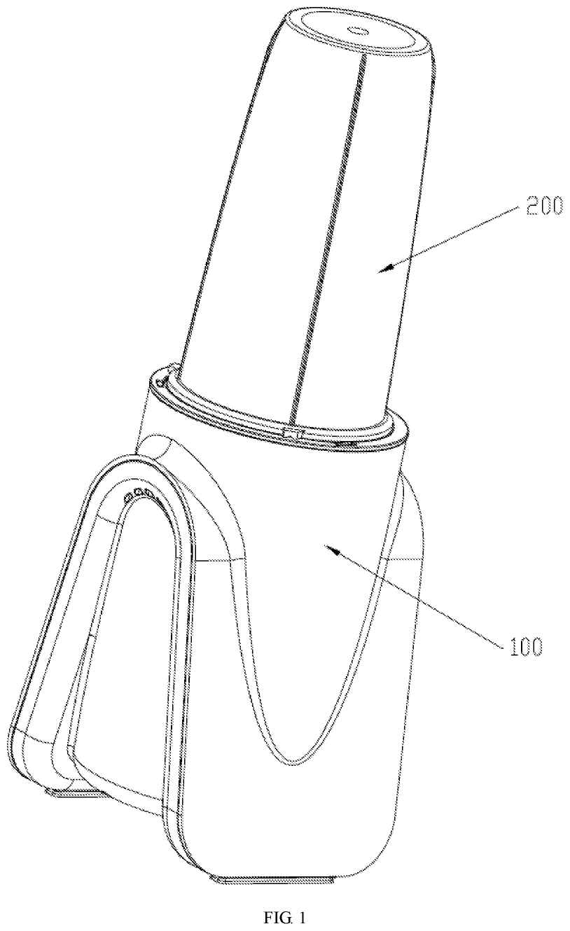

As shown in FIG. 1, a food processor includes a base 100 and a cup body 120. The base 100 includes a first accommodating cavity 110, a second accommodating cavity 120, a drive device 130 disposed in the first accommodating cavity, and a grinding blade 140 disposed in the second accommodating cavity. The grinding blade is connected to the drive device in a driving manner. The cup body 120 covers the grinding blade 140 and is detachably connected to the second accommodating cavity 120. The grinding blade includes a grinding blade body and a grinding blade holder. The grinding blade is fixed to a grinding blade shaft. The grinding blade shaft is fixed to the grinding blade holder by using bearings. The bottom end of the grinding blade shaft passes through the grinding blade holder to be connected to the drive device by splines. The grinding blade holder and the base are rotationally clamped or spirally connected.

As shown in FIG. 1, the cup body 200 includes a first surface 210, and a second surface 230 that surrounds the first surface 210 and forms a third accommodating cavity 220 with the first surface 210.

The second accommodating cavity 120 and the third accommodating cavity 220 form a food grinding and processing cavity.

The food grinding and processing cavity is provided with a pressure release device 300. The pressure release device includes a pressure release hole 310 and an air release valve 320. The air release valve 320 is movably mounted in the pressure release hole 310 so as to move along an axial direction of the pressure release hole 310 to open or block the pressure release hole 310.

In the food processor, the air release valve 320 is pushed by the difference between internal and external pressures, mainly the pressure in the food grinding and processing cavity that is greater than the pressure in the atmosphere. Therefore, the air release valve 320 moves along an axial direction of the pressure release hole 310 to open the pressure release hole 310, so as to release the air and reduce the pressure. When the pressure in the food grinding and processing cavity is equal to the pressure in the atmosphere, the air release valve 320 reversely moves along the axial direction of the pressure release hole 310 to block the pressure release hole 310.

Therefore, the pressure release hole 310 can be disposed in any position of an inner wall of the food grinding and processing cavity as long as the pressure release hole 310 can connect the food grinding and processing cavity and the external atmospheric pressure. The air release valve 320 is pushed by the pressure to open the pressure release hole 310, and the pressure release hole 310 can be restored by using a spring or gravity drop or other elastic structures, which is not limited here.

Other structures of the food processor may be identical with or similar to those of any food processor available on the market, which are not further limited here.

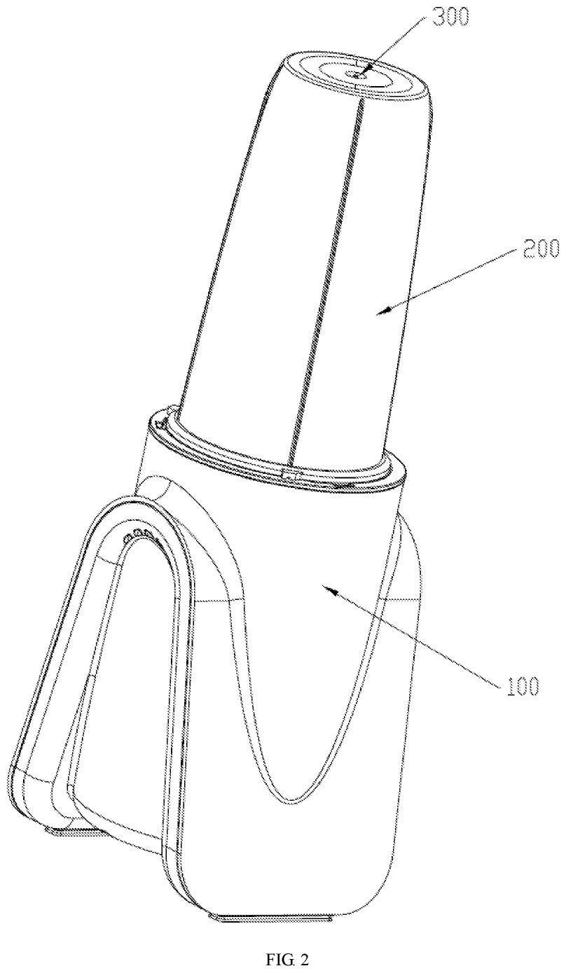

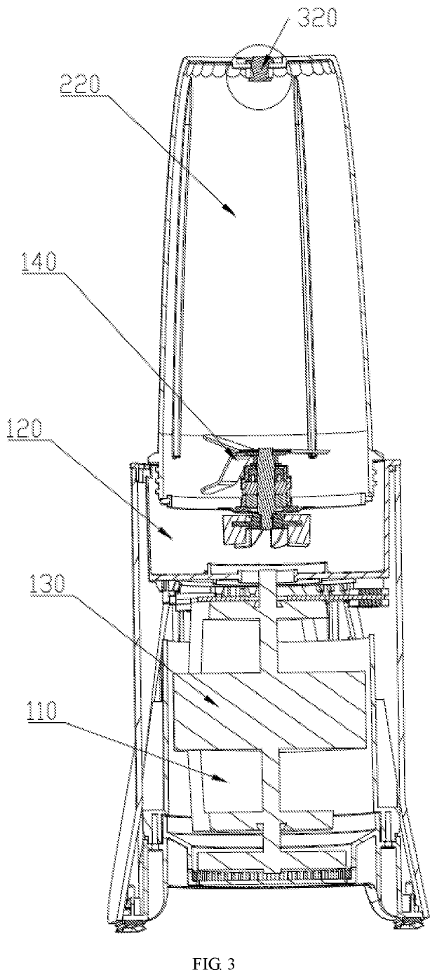

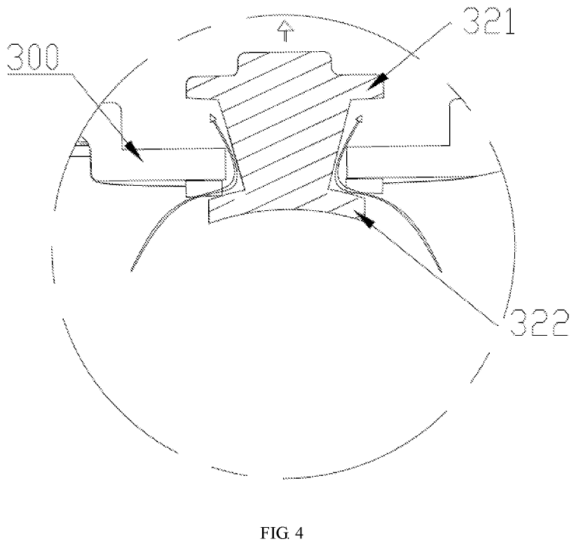

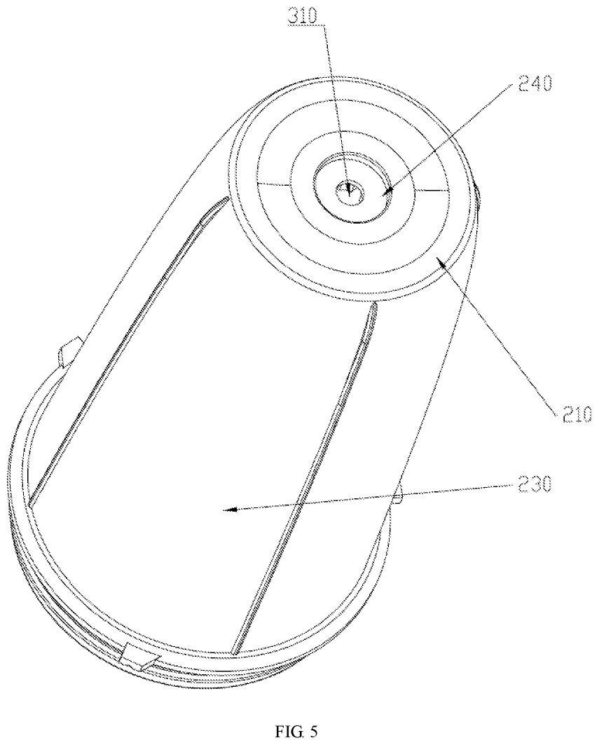

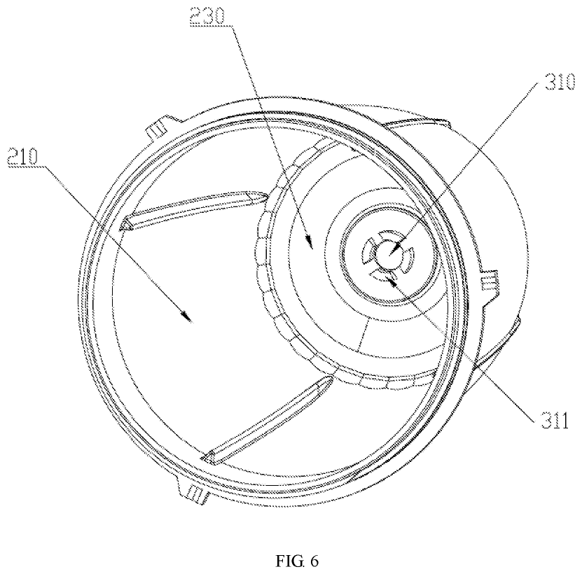

As shown in FIG. 1, FIG. 2, FIG. 3, FIG. 4, FIG. 5 and FIG. 6, in this embodiment, a specific structure of a pressure release device is provided. Here, the pressure release device is disposed on a cover body. The pressure release hole of the pressure release device is disposed on the first surface. At least one pressure release table 311 is disposed on the periphery, which is located in the third accommodating cavity, of the pressure release hole. The air release valve 320 includes a first retainer ring 321, a second retainer ring 322 and a valve stem 323 that connects the first retainer ring 321 to the second retainer ring 322. The valve stem 323 is disposed through the pressure release hole 310 such that the first retainer ring 321 is located outside the third accommodating cavity 220, and the second retainer ring 322 is located in the third accommodating cavity 220. A projection area of the first retainer ring 321 on the pressure release hole 310 is greater than an area of the pressure release hole 310, so as to block the pressure release hole 310. A projection area of the second retainer ring 322 on the pressure release hole 310 is greater than the area of the pressure release hole 310.

In this embodiment, the first retainer ring 321 is used as the plug of the pressure release hole 310 and also as a limit stop to prevent the air release valve 320 from sliding out of the pressure release hole 310 in the process of falling back. The second retainer ring 322 serves as a blocking part for preventing the air release valve from being detached from the pressure release hole 310 in the pressure release process. Specific shapes and thicknesses of the first retainer ring 321 and the second retainer ring 322 are not limited here.

The setting of the pressure release table 311 prevents a situation where the second retainer ring 322 blocks the pressure release hole 310 due to an extremely high pressure in the food grinding and processing cavity and thus it is impossible to release the pressure. Therefore, the smoothness of an air flow passage for pressure release can be guaranteed effectively to ensure safe use. The number of the pressure release tables 311 and the thickness thereof are not limited here.

In addition, in this embodiment, the pressure release hole can be used as a vacuum hole, and the food processor in this embodiment can be used as a vacuum food processor. When used as a vacuum food processor, the food processor can process and preserve food under extremely low pressure, thin air and even vacuum environments, can guarantee that nutrients such as vitamin C will not be oxidized, prevent change in colors and aroma of the food, and retain dietary fiber, such that the food tastes fresh and delicate. Compared with other food processors, the food processed by the food processor in this embodiment has no air bubbles mixed and tastes more delicate and smooth.

In this embodiment, the diameter of the valve stem is gradually reduced from the first retainer ring to the second retainer ring. With the increase of the pressure in the food grinding and processing cavity, the opened air flow passage of the pressure release hole 310 is gradually increased, thus improving the pressure release speed.

As shown in FIG. 6, a space is provided between the pressure release tables 311 in the third accommodating cavity 220 on the first surface 210. Keeping a space between the pressure release tables can ensure that there are multiple air flow channels for pressure release, which is faster and more stable. The pressure release tables may be the same or different, which is not limited here.

For more convenient processing and the stability of pressure release, the pressure release tables 311 are equally spaced around the pressure release hole.

As shown in FIG. 5, a pit 240 is disposed on the first surface 210, the pressure release hole 310 is opened on the pit 240, and the depth of the pit 240 is greater than the thickness of the first retainer ring 321.

The pit 240 can accommodate the first retainer ring 321, and when the first retainer ring 321 blocks the pressure release hole 310, an upper surface of the first surface 210 is completely horizontal, which does not affect the use and is more beautiful.

In addition, manual pressure release is possible. That is, the first retainer ring 321 is provided with a handheld end 3211. The handheld end 3211 can be gripped to pull the air release valve 320 towards a side surface of the pressure release hole 310. When the air release valve 320 is pulled towards the side surface, it can prevent steam from hurting hand. At the same time, air circulation is allowed between the food grinding and processing cavity and the atmosphere. The manual pressure release is safer and more stable.

In addition, in this embodiment, the air release valve is preferably set as a soft rubber valve. As shown in FIG. 4, during pressure release, the second retainer ring 322 of the air release valve is attached to the pressure release table 311 and deforms under the action of the steam pressure inside the food grinding and processing cavity. When the pressure release is over, the elastic deformation is restored, and the second retainer ring falls back and blocks the pressure release hole again.

The above descriptions are merely preferred embodiments of the present invention, but are not intended to limit the present invention. For those skilled in the art, the present invention may have a variety of modifications and changes. Any modification, equivalent replacement, improvement and the like made with the spirit and principle of the present invention should all be encompassed in the protection scope of the present invention.

1. A food processor, comprising a base that comprises a first accommodating cavity and a second accommodating cavity; and
a drive device disposed in the first accommodating cavity, and
a grinding blade disposed in the second accommodating cavity; the grinding blade being connected to the drive device in a driving manner; and
a cup body that covers the grinding blade and is detachably connected to the second accommodating cavity,
wherein the cup body comprises a first surface, and a second surface that surrounds the first surface and forms a third accommodating cavity with the first surface; the second accommodating cavity and the third accommodating cavity form a food grinding and processing cavity; and
the food grinding and processing cavity is provided with a pressure release device that comprises a pressure release hole and an air release valve, the air release valve being movably mounted in the pressure release hole so as to move along an axial direction of the pressure release hole to open or block the pressure release hole.

2. The food processor according to claim 1, wherein the pressure release hole is disposed on the first surface,
at least one pressure release table is disposed on the periphery, which is located in the third accommodating cavity, of the pressure release hole;
the air release valve comprises a first retainer ring, a second retainer ring and a valve stem that connects the first retainer ring to the second retainer ring; the valve stem being disposed through the pressure release hole such that the first retainer ring is located outside the third accommodating cavity, and the second retainer ring is located in the third accommodating cavity; and
a projection area of the first retainer ring on the pressure release hole is greater than an area of the pressure release hole, so as to block the pressure release hole; and a projection area of the second retainer ring on the pressure release hole is greater than the area of the pressure release hole.

3. The food processor according to claim 2, wherein the diameter of the valve stem is gradually reduced from the first retainer ring to the second retainer ring.

4. The food processor according to claim 3, wherein a space is provided between the pressure release tables.

5. The food processor according to claim 4, wherein the pressure release tables are equally spaced around the pressure release hole.

6. The food processor according to claim 5, wherein a pit is disposed on the first surface, the pressure release hole is opened on the pit, and the depth of the pit is greater than the thickness of the first retainer ring.

7. The food processor according to claim 6, wherein the first retainer ring is provided with a handheld end.

8. The food processor according to claim 7, wherein the air release valve is a soft rubber valve.
